(19) United States
(12) Patent Application Publication
(10) Pub. No.: US 2018/0375079 A1
(43) Pub. Date: Dec. 27, 2018

(54) Fire Proof Enclosure For Charging Electronic Devices

(71) Applicant: Kenneth Robison, New Castle, PA (US)

(72) Inventor: Kenneth Robison, New Castle, PA (US)

(21) Appl. No.: 16/012,850

(22) Filed: Jun. 20, 2018

Related U.S. Application Data
(60) Provisional application No. 62/523,427, filed on Jun. 22, 2017.

(51) Int. Cl. H01M 2/10; H01M 10/658

(52) U.S. Cl. CPC H01M 2/1094; A62C 3/16; H01M 10/658

(57) ABSTRACT

The claimed invention provides a solution for containing a fire in an enclosed fire proof or fire-resistant space in the event that a battery of an electronic device combusts or explodes causing a fire. By containing the fire, the claimed invention prevents damage to property and potential injury to persons.

The claimed invention relates generally to fire-proof or fire/flame retardant enclosures for charging electronic devices. This application claims the benefit of US provisional application No. 62/523,427 filed on Jun. 22, 2017.

### BACKGROUND OF THE INVENTION

### Field of the Invention

### Description of the Related Art

In today's society, it is almost unheard of to be without a cellphone as, according to recent reports, there are as many cell phone subscriptions in use as there are people on earth. Used for multiple purposes, cell phones have become critical for everyday use including placing phone calls, writing text messages, receiving and sending emails, watching movies, etc. Recent events indicate that rechargeable batteries in cell phones can malfunction and ignite while the phones are being recharged, causing significant risk of injury to cellphone users as the likelihood of homes burning down and family members dying in fires is very real. Therefore, a need exists for a new and novel solution to prevent a cell phone or any electronic device battery fire from igniting the area around it while it is charging.

Attempts have been made, although unsuccessfully, to solve this problem. One illustrative attempt can be seen with respect to U.S. Pat. No. 8,544,670 B2, which generally discloses a fire containment case for portable electronic devices. While this disclosure may address the concerns of a battery malfunction in an electronic device such as a laptop, it fails to provide for a fire containment case to be used specifically while a portable electronic device is charging.

Another attempt to meet this need can be seen with respect to U.S. Patent Application Publication No. 2008/0290094 A1, which generally discloses a fire containment case for portable electronic devices. Unfortunately, this disclosure also fails to address the concerns protecting the area around a portable device while the device is charging.

While several fire proof pouches exist in the market, none are configured to accommodate charging an electronic device. A need exists for fire proof or fire resistant enclosures for charging electronic devices, such as, but not limited to, cellphones, tablets, ear buds, speakers, etc.

### SUMMARY OF THE INVENTION

The claimed invention provides a solution for containing a fire in an enclosed fire proof or fire resistant space in the event that a battery of an electronic device combusts or explodes causing a fire while charging. By containing the fire, the claimed invention prevents damage to property and potential injury to persons. A fire caused by lithium battery explosion can heat up to 1000 degrees Celsius, therefore the enclosure in which the electronic device is charging must be resistant to the same temperature. A power bank, a smart charger, or an equivalent power provider is located inside of the enclosure and is used to charge the electronic device in a fire resistant or fire proof environment.

### BRIEF DESCRIPTION OF THE DRAWINGS

FIG. 1 is a top perspective view of a fire-retardant enclosure embodiment of the invention.

FIG. 2 is a side perspective view of the fire-retardant enclosure of FIG. 1.

FIG. 3 is a top perspective view of a fire proof enclosure embodiment of the invention in the closed position.

FIG. 4 is a perspective view of the fire proof enclosure embodiment of FIG. 3 in the open position.

FIG. 5A is a perspective view of a fire proof enclosure embodiment of the invention in the closed position.

FIG. 5B is a top view of the fire proof enclosure embodiment of FIG. 5A in the open position.

FIG. 5C is an exploded view of the fire proof enclosure embodiment of FIG. 5A.

FIG. 6 is a top perspective view of a fire proof enclosure embodiment of the invention.

### DETAILED DESCRIPTION

While the invention will be described and shown in connection with a cell phone device, it is understood that the invention is not limited in scope and any electronic device such as tablet, ear buds, speakers, etc. that needs a battery to be charged is contemplated by this disclosure. Typically lithium-ion batteries are found in most smartphones and electronics, and they have a metal oxide cathode made of a cobalt, nickel, manganese or iron mix, a porous graphite anode that holds lithium ions within it and a lithium salt electrolyte. A typical lithium ion battery within a smartphone has an energy density around 150 Watt-hours per kilogram (Wh/kg). While lithium ion battery energy density has improved since its introduction in the early 1990s, it is held back by its construction and chemistry. The more energy you put into a box, the more dangerous it's going to be, for example, when a battery heats up beyond 80 degrees Celsius you hit what is called then nal runaway, where the components start to decompose, and that's when it can explode. The fire caused by these explosions need to be contained for charging electronic devices, otherwise there is risk of harm to a people or property. A fire caused by lithium battery explosion can heat up to 1000 degrees Celsius.

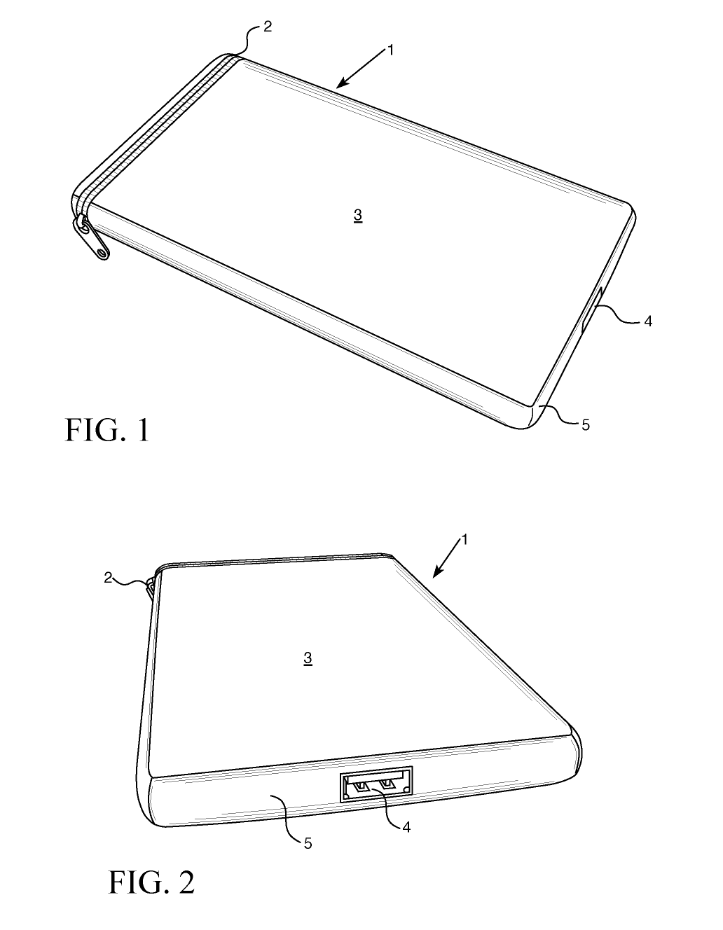

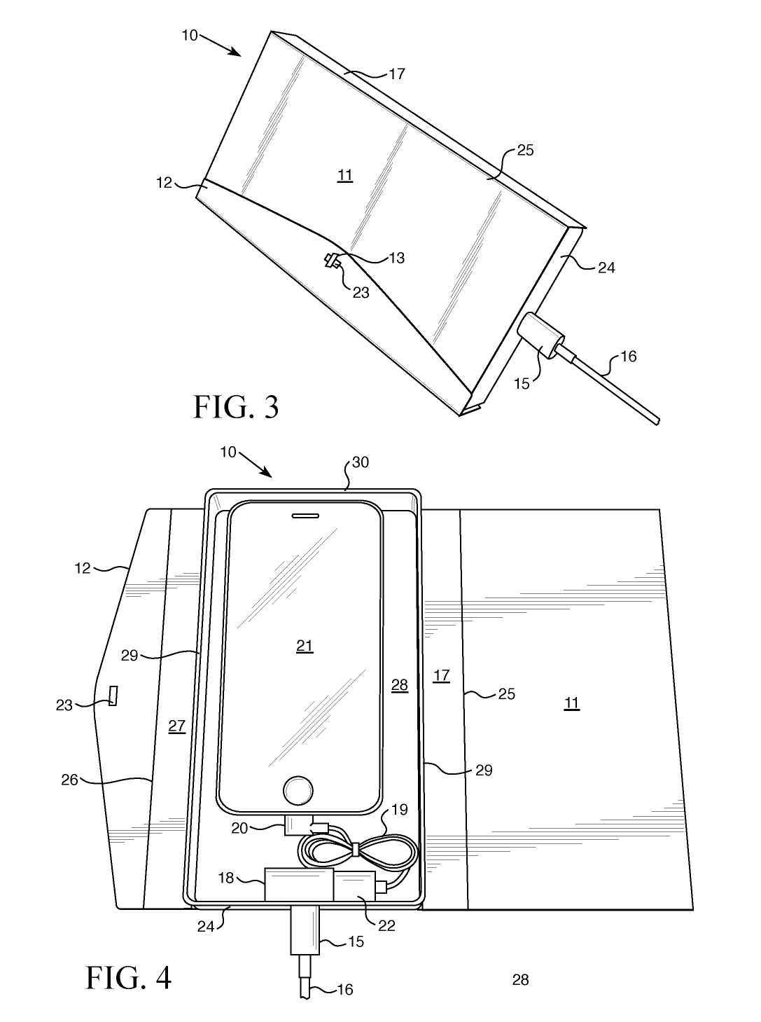

FIGS. 1 and 2 disclose a fire-retardant enclosure embodiment of the invention. Case 1 is comprised of fire retardant material that can resist temperatures of at least 1000 degrees Celsius. The fire-retardant material could be a fabric that is inherently fire retardant such as but not limited to tightly woven wool (such as kaowool), or polyesters. The fire-retardant material could also be fabrics that are chemically treated to be fire retardant by any means known in the field such as Polybrominated diphenyl ethers (PBDE). On the top surface 3 of case 1 biased towards a first lateral end of case 1 is a zipper 2. On a second lateral end of case 1 on lateral side surface 5 with charging port 4. Within the case 1 is a double female USB port. One port is facing the interior and is capable of receiving the charging wire for the electric device to be charged and the second port seen as charging port 4 is capable of receiving one end of a double male USB cable. The second end of the double male USB cable is capable of connecting to a typical plug that receives male USB ends or any other type of charging device that is capable of receiving male USB ends.

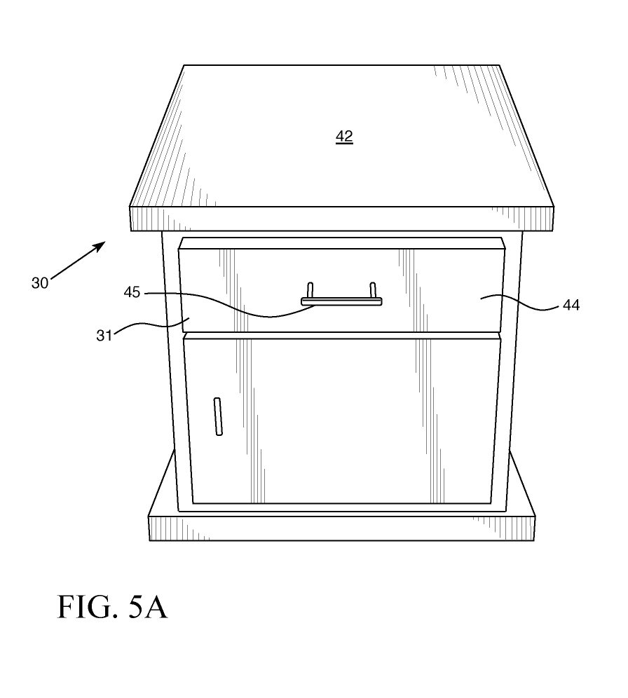

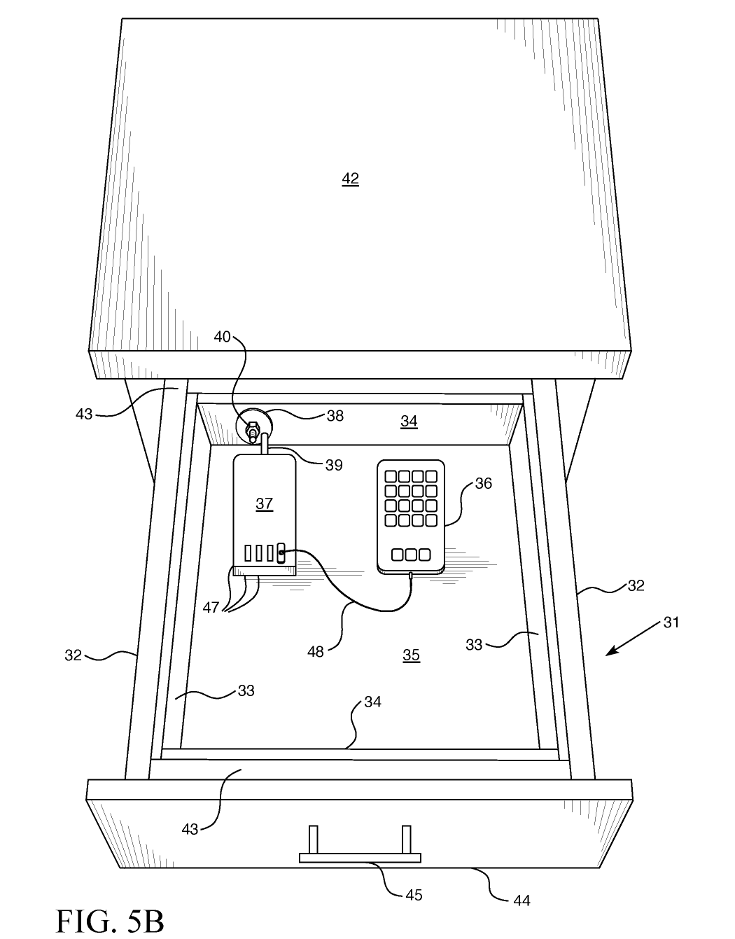

In another embodiment of the present invention depicted in FIGS. 3-4, the fire proof enclosure forms a cuboidal structure that is a portable stiff case comprised of six sides (that form the polyhedron) which are comprised of a fireproof material can withstand temperatures of at least 1000 degrees Celsius. Lightweight materials such as carbon foam, carbon/carbonized fiber, Kevlar, silicone infused fiberglass product, PVC/fiberglass material, and other comparable materials are contemplated by this disclosure. Case 10 is comprised of top side 11 on which latch 13 is attached. Shown here the latch 13 is biased towards one lateral side of top side 11, but the latch can be placed anywhere on the top side that enables it to form a cuboidal structure properly. As shown on this embodiment, on the same lateral side is attached flap 12 containing hole 23 configured to receive latch 13 which extends and secures flap 12 to top side 11. Other configurations for securing the flap including but not limited to Velcro or a zipper can are contemplated by this disclosure. An external power supply (not shown) connects to case 10 via wire 16 and exterior connector 15 through bottom lateral side 24. The open view in FIG. 4 depicts the interior of case 10. Electronic device 21 sits on bottom side 28 within longitudinal sides 29, top lateral side 30 and bottom lateral side 24; all of the sides are configured to form an enclosed cuboidal case when in a closed position. Connected to the exterior connector 15 through bottom lateral side 24 is internal power provider 18. Any feasible style of power provider such as a power bank/power pack/smart charger/power strip/surge protector/back-up battery known in the art is contemplated by this disclosure. Likewise, a fully charged power provider that is disconnected from an external power can be used to charge an electronic device with the enclosed fire proof structure. Wire 19 connects to the power provider 18 via internal connector 22 and transfers an electrical charge to electronic device 21 via electronic device connector 20. Alternatively, this disclosure also contemplates the electronic devices connecting with wireless chargers as the power provider charge the electronic device. In this embodiment, case 10 is depicted completely opened using a lateral side fold 17 located on the side opposite of flap 12. Lateral side fold 17 attaches to the top side 11 via flexible crease 25 and attaches similarly via a flexible crease to the bottom side of case 10. Lateral side fold 27 attaches to the flap 12 via flexible crease 26 and attaches similarly via a flexible crease to the bottom side of case 10. Another embodiment contemplated by this disclosure is that fire proof sides form an interior of an outer hard casing comprised of non-fireproof material. The user would place the electronic device inside of the case, plug the electronic device into the charging receptacle, and then close and secure the case. Such a case would be ideal for a user to transport to their place of employment, to hotel room while traveling, or to any place that provides charging stations such as airports.

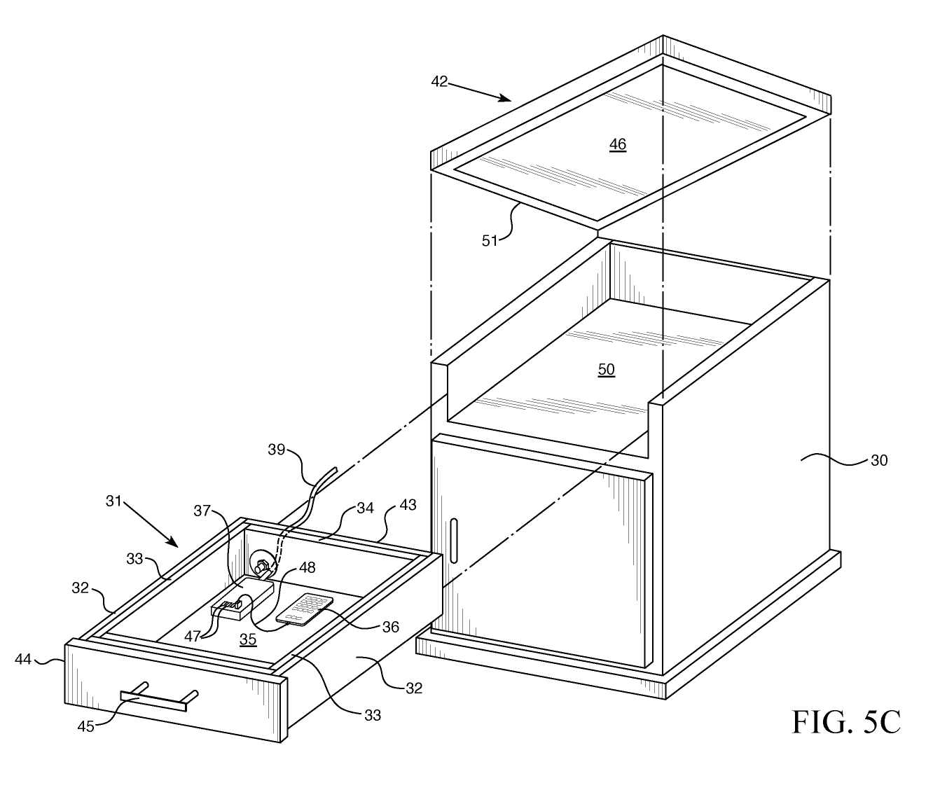

Other embodiments in this disclosure contemplate a fire proof enclosure as part of a piece of furniture, preferably as a drawer, wherein fire proof pieces, preferably comprised of tiles are configured to form an internal enclosed cuboidal structure comprised of six sides (that form the polyhedron) when the furniture drawer in the closed position. FIGS. 5A-5C depict a nightstand with a fire proof drawer. Nightstand 30 is comprised of drawer 31 with front façade 44 and handle 45 and table top 42. Drawer 31 is comprised of lateral sides 32 and cross sides 43. Though a nightstand with a certain shaped drawer is depicted in FIGS. 5A-C any comparable piece of furniture with any feasible shaped drawer is contemplated by this disclosure. The interior of drawer 31 is comprised of fireproof tiles: bottom tile 35, lateral tiles 33, and cross tiles 34. As seen in the exploded view in FIG. 5C, attached to the underside 51 of table top 42 is top tile 46 that fits snugly over space 50 where drawer 31 typically sits in the night stand. The bottom tile 35, the top tile 46, the lateral tiles 33, and the cross tiles 34 comprise the six sides (that form the polyhedron) of the fire proof cuboidal structure when the furniture drawer is in the closed position. This configuration ensures that the charging electronic device is completely surrounded by fire proof material in the enclosure. These fire proof tiles are preferably comprised of ceramic material, preferably ceramic materials that can withstand temperatures of at least 1000 degrees Celsius such as the ceramics that is sold as typical floor tile. However, any comparable ceramic material is contemplated by this disclosure. Other non-ceramic comparable fireproof materials that withstand temperatures of at least 1000 degrees Celsius are also contemplated by this disclosure. In this embodiment a power provider 37 with wire 39 extends through a short tile 34 and is capable of connecting to an external power source (not shown) located in what is typically considered the back of the drawer, though any feasible position of the power provider with a wire extending through the drawer to an external power source is contemplated by this disclosure. Any feasible style of power provider such as a power bank/power pack/smart charger/power strip/surge protector/back-up battery known in the art is contemplated by this disclosure. Likewise, a fully charged power provider that is disconnected from an external power can be used to charge an electronic device with the enclosed fire proof structure. In this embodiment, a securing system is depicted as washer 38 and a nut/bolt configuration 40 is used to secure wire 39 in a fireproof opening. Securing the wire also keeps the power provider in place within the drawer. Not shown is a matching washer on the outside one of the sides of the drawer, in FIGS. 5B and 5C, the cross side 43 located in the back of the drawer. Though shown here as a typical fender washer with a nut/bolt securing system, any feasible securing system to fireproof the opening is contemplated by this disclosure. Alternatively, an interior fireproof enclosure without an opening in one of the fireproof tiles; said enclosure accommodating a stand-alone (having no wire connected to an external power source) power provider is contemplated by this disclosure. The stand-alone power provider can be a typical power bank, but any known stand-alone power provider known in the field is contemplated by this disclosure. Electronic device 36 connects to power provider 37 via a typical means such a charging wire 48 specific for that electronic device 36 inserted to a charging port 47 on the power provider 37. Alternatively, this disclosure also contemplates the electronic devices connecting with wireless chargers as the power provider to charge the electronic device.

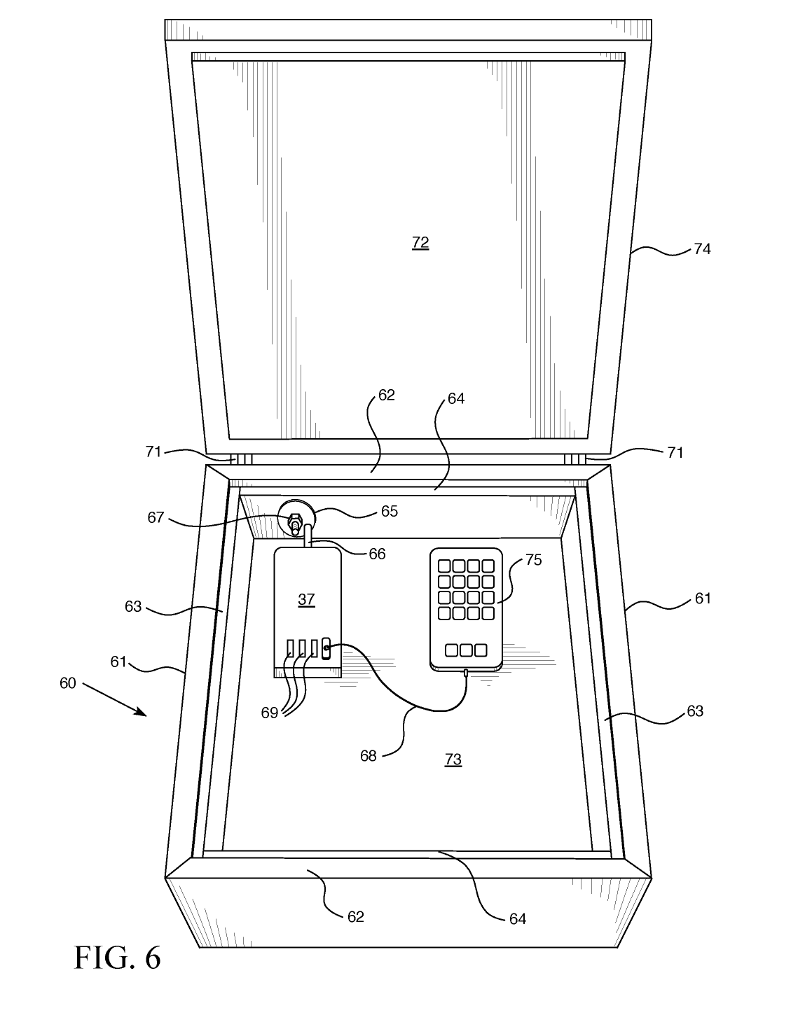

FIG. 6 depicts a stand-alone box that with fire proof enclosure wherein fire proof tiles are configured to form an internal enclosed cuboidal structure when in the box is closed. Box 60 is comprised of lateral sides 61 and cross sides 62. The interior of box 60 is comprised to top tile 72, lateral side tiles 63, cross side tile 64, and bottom tile 73 forming the internal enclosed cuboidal structure comprised of six sides (that form the polyhedron). Top closure 74 is attached to one of the cross sides 62 via hinges 71, though any attachment means that allows for the opening and closing of the box 60 is contemplated by this disclosure including a top closure that is not permanently connected and is just placed on box to form enclosure. In this embodiment a power provider 70 with wire 66 extends through a cross tile 64 and is capable of connecting to an external power source (not shown) located in what is typically considered the back of the box, though any feasible position of the power provider with a wire extending through the drawer to an external power source is contemplated by this disclosure. Any feasible style of power provider such as a power bank/power pack/smart charger/power strip/surge protector/back-up battery known in the art is contemplated by this disclosure. Likewise, a fully charged power provider that is disconnected from an external power can be used to charge an electronic device with the enclosed fire proof structure. In this embodiment, a securing system is depicted as washer 65 and a nut/bolt configuration 67 is used to secure wire 66 in a fireproof opening. Securing the wire also keeps the power provider in place within the box. Not shown is a matching washer on the outside one of the sides of the box, in FIG. 6 the cross side 62 located in the back of the box. Though shown here as a typical fender washer with a nut/bolt securing system, any feasible securing system to fireproof the opening is contemplated by this disclosure. Alternatively, an interior fireproof enclosure without an opening in one of the fireproof tiles; said enclosure accommodating a stand-alone (having no wire connected to an external power source) power provider is contemplated by this disclosure. The stand-alone power provider can be a typical power bank, but any known stand-alone power provider known in the field is contemplated by this disclosure. Electronic device 75 connects to power provider 70 via a typical means such a charging wire 68 specific for that electronic device 75 inserted to a charging port 69 on the power provider 70. Alternatively, this disclosure contemplates the electronic devices connecting with wireless chargers as the power provider to charge the electronic device. Any feasible box shape and opening with or without hinges or alternative hinging means is contemplated by this disclosure. These fire proof tiles are preferably comprised of ceramic material, preferably ceramic materials that can withstand temperatures of at least 1000 degrees Celsius. Other non-ceramic fireproof materials that withstand temperatures of at least 1000 degrees Celsius are also contemplated by this disclosure.

The claimed invention allows for an electronic device to be connected to power provider for charging its battery. In the event the electronic device overheats, the fireproof or fire-resistant enclosure will prevent the fire from spreading and damaging the room, the house, and the inhabitants.

The following are benefits of the claimed invention for users:
A convenient way to contain fires that may result when electronic are being charged.
Consumers may still use the original charging cords to connect their devices to the charging receptacles inside of the fire-resistant or fire proof enclosure.
Will eliminate or reduce the possibility of injuries, damage, or deaths resulting from fires that initiate from a charging an electronic device.
Will provide consumes will peace of mind, knowing they are doing all they can to protect themselves, their loved ones and their personal belongings.

The embodiments of the invention described herein are exemplary and numerous modifications, variations and rearrangements can be readily envisioned to achieve substantially equivalent results, all of which are intended to be embraced within the spirit and scope of the claimed invention. Furthermore, while the preferred embodiments of the invention are described in terms of the components and configurations, it is understood to that the claimed invention is not intended to be limited to those specific dimensions or configurations but is to be accorded the full breadth and scope of the spirit of the invention as disclosed in the appended claims.

What is claimed is:

1. A fireproof enclosure for charging an electronic device comprising:
fire proof tiles, the fire proof tiles configured to have an open position for a user to place the electronic device to be charged and the fire proof tiles configured to have a closed position forming an enclosed cuboidal structure forming an interior fireproof enclosure; and further comprising an opening in one of the fireproof tiles; said opening configured to be fireproof via a securing system.

2. The enclosure of claim 1 further comprising a power provider inside the enclosed cuboidal structure, the power provider capable of connecting to an external power source via a wire extending through the opening of one of the fireproof tiles, and the power provider being capable of connecting to and charging an electronic device.

3. The enclosure of claim 1 whereby the enclosed cuboidal structure forms the interior of drawer configured for a piece of furniture.

4. The enclosure of claim 1 whereby the enclosed cuboidal structure forms the interior of a stand-alone box.

5. The enclosure of claim 1 whereby the fire proof tiles are resistant to temperatures up of at least 1000 degrees Celsius.

6. The enclosure of claim 1 whereby the fire proof tiles are comprised of ceramic.

7. The enclosure of claim 2 whereby the power provider is a smart charger.

8. The enclosure of claim 2 whereby the power provider is a power bank.

9. The enclosure of claim 2 wherein the power provider is a wireless charger.

10. A fireproof enclosure for charging an electronic device comprising:
fire proof tiles, the fire proof tiles configured to have an open position for a user to place the electronic device to be charged and the fire proof tiles configured to have a closed position forming an enclosed cuboidal structure forming an interior fireproof enclosure.

11. The enclosure of claim 10 further comprised of a stand-alone power provider; the stand-alone power provider being capable of connecting to and charging an electronic device.

12. The enclosure of claim 10 whereby the enclosed cuboidal structure forms the interior of drawer configured for a piece of furniture.

13. The enclosure of claim 10 whereby the enclosed cuboidal structure forms the interior of a stand-alone box.

14. The enclosure of claim 10 whereby the fire proof tiles are resistant to temperatures of at least 1000 degrees Celsius.

15. The enclosure of claim 10 whereby the fire proof tiles are comprised of ceramic.

16. A portable fire proof case for charging an electronic device comprising:
sides comprised of a fire proof material that are configured to form an enclosed cuboidal case when in a closed position, a power provider internal to the enclosed cuboidal case, the power provider capable of connecting to an external power source via a wire extending through one of the sides comprised of fireproof material configured to form the enclosed cuboidal case, and the power provider being capable of connecting to and charging an electronic device.

17. The portable fire proof enclosure of claim 16 further comprised of a flap configured with a securing means to secure a top side of the portable fire proof enclosure.

18. The portable fire proof enclosure of claim 16 whereby the sides are comprised of a fire proof material are resistant to temperatures of at least 1000 degrees Celsius.
